(19) United States
(12) Patent Application Publication
(10) Pub. No.: US 2004/0182533 A1
(43) Pub. Date: Sep. 23, 2004

(54) Method for increasing the whiteness of paper by means of cationic polyelectrolytes

(76) Inventors: Thierry Blum, Neustadt (DE); Friedrich Linhart, Heidelberg (DE); Hans-Peter Kaub, Altrip (DE); Simon Champ, Ludwigshafen (DE); Martin Wendker, Worms (DE); Dieter Meck, Freinsheim (DE); Steffen Geiger, Fussgonheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/486,947

(22) PCT Filed: Aug. 27, 2002
(86) PCT No.: PCT/EP02/09542

(30) Foreign Application Priority Data
Sep. 3, 2001 (DE) 10142887.1
Dec. 12, 2001 (DE) 10161157.9

(51) Int. Cl. D21H 19/00; C09K 11/06

(52) U.S. Cl. 162/135; 252/301.21; 162/162; 162/168.2; 162/164.6

(57) ABSTRACT

Recording materials are produced by a process in which a mixture A comprising

i) at least one optical brightener,

ii) at least one cationic polyelectrolyte and

iii) at least one solvent is applied to the recording material.

The present invention relates to a novel process for increasing the whiteness and brightness of paper. The present invention furthermore relates to a novel process for improving the printability of papers, particularly by the inkjet method. The present invention furthermore relates to papers which have been produced by this process and the printing of papers which have been produced by this process. The present invention moreover relates to mixtures of optical brighteners in a solvent with cationic polyelectrolytes.

A large proportion of the white papers which are used in offices and households are written on and printed on in various ways. They are written on traditionally by hand with aqueous inks or using ballpoint pens, they are printed on in copiers or they are printed on by means of a printer connected to a personal computer (PC) instead of the previously used typewriter. Said printer may be, for example, a conventional dot matrix, laser or ink-jet printer. In view of the requirements of the various writing and printing methods with respect to such papers, they are frequently often referred to as multipurpose papers.

The printing of papers, boards, cardboards, paper-like materials or textiles, referred to below as recording materials for short, by means of digital printing methods, one of which is the ink-jet method, is becoming increasingly important in the printing industry. The use of inkjet printers with computers for home use is increasing to a particular extent.

In the traditional printing methods, a printing plate treated with ink is generally pressed onto the paper. In most cases, the printing inks are not dissolved in water, whereas in the inkjet method ink dissolved in water is sprayed onto the recording material. The requirements on the part of the printer with respect to recording material, e.g. paper, are therefore very different from those in the case of the traditional printing methods.

The inkjet method sets the greatest requirements with respect to the quality of the paper. In this method, aqueous inks which contain water-soluble dyes are sprayed onto the paper from fine nozzles. The paper should absorb the water as rapidly as possible so that the image cannot be smudged. At the same time, however, the dye must be fixed with crisp contours at the point of contact of the inkjet and must be prevented from penetrating too deeply into the paper. Otherwise, a part of the ink will also be visible at the back of the paper, something which is referred to as strike-through. Furthermore, the dye must not migrate out of the contact area in the plane of the paper, either through capillary forces between the paper fibers or through the interior of the fiber itself (wicking), and it also must not migrate into adjacent dye areas (bleeding). A high degree of whiteness of the paper is very important in order for good color reproduction to be ensured in particular in the case of pale colors and pastel hues where the background shows through particularly strongly.

In order to impart the desired properties to the paper surface, the finishing thereof is essential. Usually, base papers are coated with special pigment-containing coating slips for this purpose and then give inkjet papers. High-quality inkjet papers are generally coated with coating slips which contain finely divided silica as pigment and, for example, polyvinyl alcohol, polyvinylpyrrolidone and a cationic polymer, e.g. polydiallyldimethylammonium chloride, as binders and assistants (cf. for example G. Morea-Swift, H. Jones, THE USE OF SYNTHETIC SILICAS IN COATED MEDIA FOR INK-JET PRINTING, in 2000 TAPPI Coating Conference and Trade Fair Proceedings, 317-328).

However, the papers produced in this manner are relatively expensive, difficult to produce alongside other paper grades and, owing to their special coating, often not very suitable for other writing and printing methods and do not meet the requirements with respect to the abovementioned multipurpose papers.

Coating slips substantially comprise a generally white pigment, a polymeric binder and additives which influence the rheological and other properties of the coating slip and the properties of the surface of the coated recording material in the desired context. Such additives are frequently also referred to as cobinders. By means of the binder, the pigments are fixed on the recording material and the cohesion in the resulting coating is ensured.

As a result of the coating with paper coating slips, base papers acquire a smooth, uniformly white surface. The coating slips also improve the printability of the recording material.

The coating of paper with paper coating slips is well known, cf. for example The Essential Guide to Aqueous Coating of Paper and Board, T. W. R. Dean (ed.), published by the Paper Industry Technical Association (PITA), 1997.

One of the most important objects of coating paper with pigment-containing coating slips is an increase in the whiteness of the paper.

One of the most important objects in the production of papers and cardboards which are to be written on or printed on, also referred to below as graphic arts papers, is a high degree of whiteness of the surface of the paper or of the cardboard. A high degree of whiteness not only imparts the impression of cleanliness and safety but, owing to the sharper contrast with the ink, also increases the legibility of the text, particularly in poor illumination. A particular advantage of a high degree of whiteness is evident when the paper or the cardboard is to be printed on, written on or painted in color. The whiter the background, the better and more natural is the color contrast, particularly when writing, printing or painting with pale or translucent colors or pastel hues. Owing to the recent increasing use of waste paper in the production of graphic arts papers, such a product of the papermaker is substantially grayer than with the use of fresh fibers.

For these reasons, the papermakers make considerable efforts to increase the whiteness of their product, particularly when it is paper for graphic arts purposes. Even in the production of the raw materials, whether chemical pulp, mechanical pulp or pigment, a considerable effort is made to obtain these raw materials in as white a form as possible. In the actual papermaking, all assistants and conditions which might impair the whiteness of the paper are avoided.

A known method for increasing the whiteness and brightness of paper is the use of optical whitening agents or optical brighteners, which, in accordance with the current prior art, are added to the pulp or applied to the paper in various operations of papermaking and of paper finishing.

These are dye-like fluorescent compounds which absorb the short-wave ultraviolet light not visible to the human eye and emit it as longer-wave blue light, with the result that the human eye perceives a higher degree of whiteness and the degree of whiteness is thus increased.

The optical brighteners used in the paper industry are generally 1,3,5-triazinyl derivatives of 4,4′-diaminostilbene-2,2′-disulfonic acid, which may carry additional sulfo groups, for example altogether 2, 4 or 6. An overview of such brighteners is to be found, for example, in Ullmann's Encyclopedia of Industrial Chemistry, Sixth Edition, 2000 Electronic Release, OPTICAL BRIGHTENERS—Chemistry of Technical Products. However, recent brightener types are also suitable, for example derivatives of 4,4′-distyrylbiphenyl, as likewise described in the abovementioned Ullmann's Encyclopedia of Industrial Chemistry.

The optical whitening agents can be used in various phases of papermaking and paper finishing. The optical brighteners can be added, for example, to the paper slip but may also be added in a size press together with surface sizes or strength agents, e.g. starch, or together with further assistants. Optical brighteners are most frequently used in paper coating slips in which paper and cardboard are coated, in a plurality of layers, particularly in the uppermost layer which is visible to the observer. It is important for the brightener to remain in this layer and not migrate into deeper layers of the paper. It should be uniformly distributed over the area and at the same time be bound so strongly in this uppermost layer that it is not dissolved away by solvents, e.g. water.

However, the use of the optical brighteners in the coating slip leads to optimum success only when they are not only optimally distributed in the final coating of the paper but also present in optimum chemical structure and conformation since, for example in the case of stilbenes, only the trans form is optically active and this exhibits maximum fluorescence only when it is distributed in monomolecular form and is held in a plane (K. P. Kreutzer, Grundprozesse der Papiererzeugung 2: Grenzflächenvorgänge beim Einsatz chemischer Hilfsmittel, H.-G. Völkel and R. Grenz (editors), PTS München, 2000, PTS manuscript: PTS-GPE-SE 2031-2).

On addition to the paper slip, this occurs in general as a result of the adsorption onto the cellulose. When used in the surface, either by means of application with a size press or by means of coating with a coating slip, polymeric compounds which reinforce the effect of the optical brightener in the coat and are referred to as activator, booster, cobinder or carrier are added to the paper coating slip. An important function of the cobinders used in the coating slips in addition to the binders is their brightener-activating effect. Water-soluble polymers, e.g. polyvinyl alcohol, carboxymethylcellulose, anionic or nonionic degraded starches, casein, soybean protein, water-soluble styrene/acrylate copolymers, urea/formaldehyde resins, melamine/formaldehyde resins, polyglycols and acrylic ester-containing copolymers can be used as suitable cobinders (cf. for example K. P. Kreutzer, loc cit).

Among these carriers, polyvinyl alcohol usually has the most advantageous effect with brighteners, cf. for example W. Bieber, A. Brockes, B. Hunke, J. Krüsemann, D. Loewe, F. Müller, P. Mummenhoff in Blankophor®—Optische Aufheller für die Papierindustrie, Bayer AG, Business Unit Dyes, Leverkusen, SP 600, 8.89, pages 63-64.

The application of an aqueous brightener solution to the paper without a carrier is known but is carried out only in special cases (W. Bieber et al., loc cit, pages 56, 62). In the International Patent Application WO 01/21891, the application of an aqueous brightener solution to a coated paper is described. This application also states that the brightener can be applied to the coated paper together with a carrier, such as starch, carboxymethylcellulose or polyvinyl alcohol, if a carrier property is lacking in the coat. Nothing is stated with regard to the ratio of optical brightener to polyvinyl alcohol. All that is mentioned is an aqueous solution of 10% by weight of optical brightener (commercial product) and 3% of dissolved starch (page 7, 3rd paragraph).

EP-A 192 600 describes aqueous preparations of at least one optical brightener, polyethylene glycol (for stabilization) and water, which can be used as an optical brightener for paper coating slips and to which other coating slip components are added for this purpose.

It is an object of the present invention to increase the whiteness of recording materials by a simple process step.

We have found that this object is achieved by a process for the production of recording materials, wherein a mixture A comprising

i) at least one optical brightener,

ii) at least one cationic polyelectrolyte and

iii) at least one solvent

is applied to the recording material.

Cationic polyelectrolytes are to be understood as meaning polymers which carry positive charges distributed over the polymer chain, and those which may be nonionic in the form of dried substances, owing to their basic character, are protonated in water or other solvents and therefore carry positive charges.

Usually, the mixtures A comprise

from 0.05 to 5, preferably 0.1-3, particularly preferably 0.2-2, % by weight of i),

from 1 to 30, preferably 2-20, particularly preferably 5-15, % by weight of ii) and

from 98.95 to 65, preferably 97.9-77, particularly preferably 94.8 to 83, % by weight of iii),

based on 100% by weight of the mixture. If other assistants typical for paper (see below) are contained, the content of solvent iii) is reduced accordingly.

It has surprisingly been found that the whiteness of recording materials, in particular of paper and cardboard, can be very simply and effectively increased if suitable mixtures of optical brighteners and certain cationic polyelectrolytes in a solvent are applied, for example, to the surface of the recording materials. Particularly surprising in the case of this process is that this is successful contrary to the general state of knowledge, according to which cationic polyelectrolytes lead to extinguishing of the fluorescence of the conventional economical anionic optical brighteners (cf. for example K. P. Kreutzer, loc cit, pages 8-22; cf. W. Bieber et al., loc cit, pages 58, 65, 71) and according to which these optical brighteners and cationic electrolytes are mutually precipitated (cf. w. Bieber et al., loc cit, page 59). These views are widely held in the paper industry.

In addition, the recording materials can be printed on by means of the inkjet method and give substantially better color reproduction and substantially better crispness of contour than conventional papers.

Furthermore, it has been found that commercial solutions of optical brighteners can be mixed with aqueous solutions of cationic polyelectrolytes and that these mixtures have a long shelf-life, although a person skilled in the art would have to assume that complexes or associates would form from the molecules of the brightener and the polymer molecules, which complexes or associates would usually have to be water-insoluble on the basis of the experience of a person skilled in the art (cf. W. Bieber et al., loc cit, page 59).

The problem of preparing stable solutions of optical brighteners is disclosed, for example, in EP-A 192 600, page 1.

The polymers and copolymers ii) which can be used in the novel process, referred to as (co)polymers in this document, contain at least one N-vinylcarboxamide, e.g. of the formula (IIa), in the form of polymerized units.

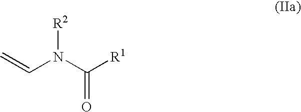

In formula (IIa), R¹ and R², independently of one another, are hydrogen or C₁- to C₂₀-alkyl, it being possible for the alkyl radical to be straight-chain or branched.

R¹ and R², independently of one another, are preferably hydrogen or C₁- to C₁₀-alkyl, particularly preferably hydrogen or C₁- to C₄-alkyl, very particularly preferably hydrogen or methyl, in particular hydrogen.

R¹ and R² together may also form a straight or branched chain containing 2 to 8, preferably 3 to 6, particularly preferably 3 to 5, carbon atoms. If desired, one or more carbon atoms can be replaced by heteroatoms, e.g. oxygen, nitrogen or sulfur.

Examples of R¹ and R² are methyl, ethyl, isopropyl, n-propyl, n-butyl, isobutyl, sec-butyl, tert-butyl, n-hexyl, n-heptyl, 2-ethylhexyl, n-octyl, n-decyl, n-undecyl, n-dodecyl, n-tetradecyl, n-hexadecyl, n-octadecyl and n-eicosyl.

Examples of R¹ and R² which together form a chain are 1,2-ethylene, 1,2-propylene, 1,3-propylene, 2-methyl-1,3-propylene, 2-ethyl-1,3-propylene, 1,4-butylene, 1,5-pentylene, 2-methyl-1,5-pentylene, 1,6-hexylene and 3-oxa-1,5-pentylene.

Examples of such N-vinylcarboxamides according to formula (IIa) are N-vinylformamide, N-vinylacetamide, N-vinylpropionamide, N-vinylbutyramide, N-vinylisobutyramide, N-vinyl-2-ethylhexanamide, N-vinyldecanamide, N-vinyldodecanamide, N-vinylstearamide, N-meth-N-vinylformamide, N-methyl-N-vinylacetamide, N-methyl-N-vinylpropionamide, N-methyl-N-vinylbutyramide, N-methyl-N-vinylisobutyramide, N-methyl-N-vinyl-2-ethylhexanamide, N-methyl-N-vinyldecanamide, N-methyl-N-vinyldodecanamide, N-methyl-N-vinylstearamide, N-ethyl-N-vinylformamide, N-ethyl-N-vinylacetamide, N-ethyl-N-vinylpropionamide, N-ethyl-N-vinylbutyramide, N-ethyl-N-vinylisobutyramide, N-ethyl-N-vinyl-2-ethylhexanamide, N-ethyl-N-vinydecanamide, N-ethyl-N-vinyldodecanamide, N-ethyl-N-vinylstearamide, N-isopropyl-N-vinylformamide, N-isopropyl-N-vinylacetamide, N-isopropyl-N-vinylpropionamide, N-isopropyl-N-vinylbutyramide, N-isopropyl-N-vinylisobutyramide, N-isopropyl-N-vinyl-2-ethylhexanamide, N-isopropyl-N-vinyldecanamide, N-isopropyl-N-vinyldodecanamide, N-isopropyl-N-vinylstearamide, N-n-butyl-N-vinylformamide, N-n-butyl-N-vinylacetamide, N-n-butyl-N-vinylpropionamide, N-n-butyl-N-vinylbutyramide, N-n-butyl-N-vinylisobutyramide, N-n-butyl-N-vinyl-2-ethylhexanamide, N-n-butyl-N-vinyldecanamide, N-n-butyl-N-vinyldodecanamide, N-n-butyl-N-vinylstearamide, N-vinylpyrrolidone and N-vinylcaprolactam. N-Vinylformamide, N-vinylacetamide, N-methyl-N-vinylformamide, N-methyl-N-vinylacetamide, N-vinylpyrrolidone and N-vinylcaprolactam are preferred, and N-vinylformamide is particularly preferred.

The preparation of the (co)polymers suitable for the novel process is known per se.

For example, the preparation of the polymers and copolymers of N-vinylformamide (R¹=R²═H in (IIa)), which can be used for the novel process, is described in EP-B1 71 050.

The synthesis of N-alkyl-N-vinylcarboxamides and the polymers and copolymers thereof is also known or is effected by known methods, cf. for example Kirk-Othmer, Encyclopedia of Chemical Technology, 4th edition, Volume 24, J. Wiley & Sons, NY, 1995, N-vinylamide polymers, page 1070; Uchino, N., Machida, S., Japan. Kokai JP 51100188 (C.A. 86:73393) or DE-A 42 41 117.

The preparation of polymers and copolymers of N-vinylpyrrolidone is known, for example, from Handbook of Water-Soluble Gums and Resins, Robert L. Davidson ed., McGraw-Hill, New York, 1980.

The (co)polymers which can be used according to the invention are obtainable, for example, by (co)polymerization of

a) from 5 to 100 mol % of one or more N-vinylcarboxamides, for example of the formula (IIa),

b) from 0 to 95 mol % of monoethylenically unsaturated carboxylic acids of 3 to 8 carbon atoms and/or the alkali metal, alkaline earth metal and ammonium salts thereof and, if required,

c) up to 30 mol % of other monoethylenically unsaturated compounds which are copolymerizable with the monomers a) and b) and, if required,

d) up to 2 mol % of compounds which have at least two ethylenically unsaturated nonconjugated double bonds in the molecule,

the sum always being 100 mol %, and, if required, subsequently partial or complete elimination of the carboxyl groups from the N-vinylcarboxamide units incorporated in the (co)polymer, with formation of amino or ammonium groups.

Suitable monomers of group a) are, for example, the abovementioned N-vinylcarboxamides of the formula (IIa).

For the preparation of the (co)polymers, said monomers can be used either alone or as a mixture with one another. The (co)polymers contain the monomers of group a) in amounts of from 5 to 100, preferably from 30 to 100, mol % in the form of polymerized units.

Suitable monomers of group b) are monoethylenically unsaturated carboxylic acids of 3 to 8 carbon atoms and the water-soluble salts of these monomers. This group of monomers includes, for example, acrylic acid, methacrylic acid, dimethylacrylic acid, ethacrylic acid, maleic acid, citraconic acid, methylenemalonic acid, allylacetic acid, vinylacetic acid, crotonic acid, fumaric acid, mesaconic acid and itaconic acid. From this group of monomers, acrylic acid, methacrylic acid, maleic acid or mixtures of said carboxylic acids, in particular mixtures of acrylic acid and maleic acid or mixtures of acrylic acid and methacrylic acid, are preferably used. The monomers of group b) can be used either in the form of the free carboxylic acids or in partially or completely neutralized form in the copolymerization. For the neutralization of the monoethylenically unsaturated carboxylic acids, for example, alkali metal bases, alkaline earth metal bases, ammonia or amines, e.g. sodium hydroxide solution, potassium hydroxide solution, sodium carbonate, potassium carbonate, sodium bicarbonate, magnesium oxide, calcium hydroxide, calcium oxide, ammonia, triethylamine, methanolamine, diethanolamine, triethanolamine, morpholine, diethylenetriamine or tetraethylenepentamine, are used. The copolymers contain at least one monomer from group b) in an amount of from 95 to 0, preferably from 70 to 0, mol % in the form of polymerized units.

The copolymers of the monomers a) and b) can, if required, be modified by using in the copolymerization at least one other monoethylenically unsaturated compound which is copolymerizable with the monomers a) and b). Suitable monomers of group c) are, for example, the esters, amides and nitriles of the carboxylic acids stated under a), e.g. methyl acrylate, ethyl acrylate, methyl methacrylate, ethyl methacrylate, n-butyl acrylate, hydroxyethyl acrylate, 2- or 3-hydroxypropyl acrylate, 2- or 4-hydroxybutyl acrylate, hydroxyethyl methacrylate, 2- or 3-hydroxypropyl methacrylate, hydroxyisobutyl acrylate, hydroxyisobutyl methacrylate, monomethyl maleate, dimethyl maleate, monoethyl maleate, diethyl maleate, 2-ethylhexyl acrylate, 2-ethylhexyl methacrylate, acrylamide, methacrylamide, N,N-dimethylacrylamide, N-tert-butylacrylamide, acrylonitrile, methacrylonitrile, 2-dimethylaminoethyl acrylate, 2-dimethylaminoethyl methacrylate, 2-diethylaminoethyl acrylate, 2-diethylaminoethyl methacrylate and the salts of the last-mentioned monomers with carboxylic acids or mineral acids and the quaternized products. Other suitable monomers of group c) are acrylamidoglycolic acid, vinylsulfonic acid, allylsulfonic acid, methallylsulfonic acid, styrenesulfonic acid, 3-sulfopropyl acrylate, 3-sulfopropyl methacrylate and acrylamidomethylpropanesulfonic acid and monomers containing phosphonic acid groups, such as vinyl phosphate, allyl phosphate and acrylamidomethylpropanephosphonic acid. Further suitable compounds of this group are N-vinyl-2-methylimidazoline, vinyl acetate and vinyl propionate. It is of course also possible to use mixtures of said monomers of group c), for example mixtures of acrylic esters and vinyl acetate, mixtures of different acrylic esters, mixtures of acrylic esters and acrylamide or mixtures of acrylamide and 2-hydroxyethyl acrylate. Of the monomers of group c), acrylamide, acrylonitrile, vinyl acetate, N-vinylimidazole or mixtures of these monomers, e.g. mixtures of acrylamide and vinyl acetate or mixtures of acrylamide and acrylonitrile, are preferably used. If the monomers of group c) are used for modifying the copolymers, they are present in amounts of up to 30, preferably from 1 to 20, mol % in the copolymers in the form of polymerized units.

The (co)polymers of the monomers a) and b) and, if required, c) may furthermore be modified by carrying out the copolymerization in the presence of at least one monomer of group d), which comprises compounds which have at least two ethylenically unsaturated, nonconjugated double bonds in the molecule. The presence of monomers of group d) in the copolymerization results in an increase in the K value (see below) of the copolymers. Suitable compounds of group d) are, for example, methylenebisacrylamide, esters of acrylic acid and methacrylic acid with polyhydric alcohols, e.g. glycol diacrylate, glyceryl triacrylate, glycol dimethacrylate, glyceryl trimethacrylate and polyethylene glycols or polyols at least diesterified with acrylic acid or methacrylic acid, such as pentaerythritol and glucose. Suitable crosslinking agents are moreover divinylbenzene, divinyldioxane, trimethylolpropane, trimethylolethane, pentaerythrityl triallyl ether, pentaallylsucrose and diallylammonium chloride. From this group of compounds, water-soluble monomers, such as glycol diacrylate and glycol diacrylates of polyethylene glycols having a molecular weight of up to 3 000 are preferably used. If the monomers of group d) are used for modifying the copolymer, the amounts used are up to 2 mol %. In the case of their use, they are preferably contained in an amount of from 0.01 to 1 mo % in the copolymers in the form of polymerized units.

It is preferable to use compounds which are obtainable by (copolymerization) of

a) from 30 to 100 mol % of N-vinylformamide, N-vinylacetamide, N-methyl-N-vinylformamide, N-methyl-N-vinylacetamide, N-vinylpyrrolidone or N-vinylcaprolactam or mixtures thereof,

b) from 70 to 0 mol % of acrylic acid, methacrylic acid and/or the alkali metal, alkaline earth metal, ammonium or amine salts thereof or mixtures thereof and

c) from 0 to 30 mol % of acrylamide, acrylonitrile, vinyl acetate, N-vinylimidazole or mixtures thereof,

the sum always being 100 mol %, and, if required, subsequent partial or complete hydrolysis of the N-vinylcarboxamide units incorporated as polymerized units.

Examples are homopolymers of N-vinylformamide, copolymers of N-vinylformamide, acrylic acid and acrylamide, of N-vinylformamide, acrylic acid and acrylonitrile, of N-vinylformamide, acrylic acid and vinyl acetate, of N-vinylformamide, acrylic acid and N-vinylpyrrolidone, of N-vinylformamide, acrylic acid, acrylonitrile and vinyl acetate or of N-vinylformamide, acrylic acid, acrylamide and acrylonitrile. In the copolymers described last, some or all of the acrylic acid can be replaced by methacrylic acid. Acrylic acid or methacrylic acid can be partially or completely neutralized with sodium hydroxide solution or potassium hydroxide solution, calcium hydroxide or ammonia.

The (co)polymers are prepared by known free radical processes, for example solution, precipitation, suspension or emulsion polymerization using compounds which form free radicals under the polymerization conditions.

The polymerization temperatures are usually from 30 to 200° C., preferably from 40 to 110° C., particularly preferably from 40 to 100° C., if required at reduced or superatmospheric pressure. Suitable initiators are, for example, azo and peroxy compounds and the conventional redox initiator systems, such as combinations of hydrogen peroxide and compounds having a reducing effect, e.g. sodium sulfite, sodium bisulfite, sodium formaldehyde sulfoxylate and hydrazine. These systems can, if required, additionally contain small amounts of a heavy metal salt.

The (co)polymers are preferably prepared by solution polymerization in water, the monomers of group b) preferably being used in salt form and the pH during the polymerization being kept at from 4 to 10, preferably from 6 to 8. In order to keep the pH constant during the copolymerization, it is expedient to add small amounts, e.g. from 0.5 to 2% by weight, of a buffer, such as disodium hydrogen phosphate. Water-soluble azo compounds, such as 2,2′-azobis(2-methylpropionamidine) dihydrochloride., 2,2′-azobis(4-methoxy-2,4-dimethylvaleronitrile), 2,2′-azobis(2-methyl-N-phenylpropionamidine) dihydrochloride, 2,2′-azobisisobutyronitrile, 2,2′-azobis(2-amidinopropane) hydrochloride or 4,4′-azobis(4′-cyanopentanoic acid), are preferably used as a polymerization initiator.

Said compounds are generally used in the form of aqueous solutions or dispersions, the lower concentration being determined by the amount of water which is acceptable in the (co)polymerization and the upper concentration being determined by the solubility of the relevant compound in water. In general, the concentration is from 0.1 to 30, preferably from 0.5 to 20, particularly preferably from 1.0 to 10, % by weight, based on the solution.

In this document, dispersion is used as a general term according to Römpp Chemie Lexikon—CD Version 1.0, Stuttgart/N.Y.: Georg Thieme Verlag, 1995, and includes emulsions, suspensions and solutions.

The amount of initiators is in general from 0.1 to 10, preferably from 0.5 to 5, % by weight, based on the monomers to be (co)polymerized. It is also possible to use a plurality of different initiators in the (co)polymerization.

For example, water, alcohols, such as methanol, ethanol, n-propanol, isopropanol, n-butanol or isobutanol, or ketones, such as acetone, ethyl methyl ketone, diethyl ketone or isobutyl methyl ketone, can be used as solvents or diluents for the polymerization.

In order to prepare low molecular weight (co)polymers, the (co)polymerization is carried out in the presence of a regulator. Suitable regulators are, for example, secondary alcohols, such as isopropanol and sec-butanol, hydroxylamine, formic acid and mercapto compounds, such as mercaptoethanol, mercaptopropanol, mercaptobutanol, thioglycolic acid, thiolactic acid, tert-butyl mercaptan, octyl mercaptan and dodecyl mercaptan. The regulators are usually used in amounts of from 0.01 to 5% by weight, based on the monomers used. The secondary alcohols are used as regulators, the (co)polymerization can also be carried out in the presence of substantially larger amounts, for example up to 80% by weight, based on the monomers. In these cases, the secondary alcohols are simultaneously solvents for the monomers.

The (co)polymers thus obtainable have, as a rule, K values of from 20 to 300, preferably from 50 to 250. The K values stated in this document are determined according to H. Fikentscher in 5% strength aqueous sodium chloride solution at pH 7, 25° C. and a polymer concentration of 0.1% by weight.

The (co)polymerization can, however, also be carried out in another manner known per se to a person skilled in the art, for example as solution, precipitation, water-in-oil emulsion or inverse suspension polymerization. Solution polymerization is preferred.

In the emulsion polymerization, ionic and/or nonionic emulsifiers and/or protective colloids or stabilizers are used as interface-active compounds.

Depending on polymerization conditions, (co)polymers having a different molecular weight which is characterized in this document with the aid of the Fikentscher K values are obtained in the (co)polymerization. (Co)polymers having a high K value, for example above 80, are preferably prepared by (co)polymerization of N-vinylcarboxamide, for example of the formula (IIa), in water. (Co)polymers having a high K value are-moreover obtained, for example, by (co)polymerization of monomers in the form of inverse suspension polymerization or by (co)polymerization of the monomers by the water-in-oil polymerization process.

In the inverse suspension polymerization and the water-in-oil polymerization process, saturated hydrocarbons, for example hexane, heptane, cyclohexane or decalin, or aromatic hydrocarbons, such as benzene, toluene, xylene and cumene, are used as the oil phase. The ratio of oil phase to aqueous phase in the inverse suspension polymerization is, for example, from 10:1 to 1:10.

(Co)polymers having a low K value, for example below 80, are obtained if the (co)polymerization is carried out in the presence of polymerization regulators or in a solvent which regulates the (co)polymerization, e.g. alcohols, such as methanol, ethanol, n-propanol or isopropanol, or ketones, such as acetone, ethyl methyl ketone, diethyl ketone or isobutyl methyl ketone.

(Co)polymers having low molecular weights and accordingly low K values are furthermore obtained with the aid of the conventional methods, i.e. use of relatively large amounts of polymerization initiator or use of polymerization regulators or combinations of said measures.

The molecular weight of the (co)polymers which can be used according to the invention is not limited. (Co)polymers having K values of from 20 to 150 are preferred, K values of from 30 to 100 being particularly preferred.

The (co)polymers containing N-vinylcarboxamides, for example of the formula (IIa), and in particular N-vinylformamide, in the form of polymerized units can be used, according to the invention, both in partly or completely cleaved form and in uncleaved form. A degree of hydrolysis of the carboxyl group of from 5 to 90, particularly preferably from 10 to 50, mol %, based on the N-carboxamide units contained in the (co)polymer, is preferred.

Further cationic polyelectrolytes ii) are known. For example, polymers which are known by the chemical trivial names polyvinylamine, polyallylamine, poly(diallyldimethylammonium chloride), cationic polyvinylformamide, cationic polyvinylpyrrolidone, cationic polyvinylacetamide, cationic polyvinylmethylformamide, cationic polyvinylmethylacetamide, poly(dimethylaminopropylmethacrylamide), poly(dimethylaminoethyl acrylate), poly(diethylaminoethyl acrylate), poly(acryloylethyltrimethylammonium chloride), poly(acrylamido propyltrimethylammonium chloride), poly(methacrylamidotripropyltrimethylammonium chloride), cationic polyacrylamide, poly(vinylpyridine), hexadimethrine bromide, poly(dimethylamine-co-epichlorohydrin), poly(dimethylamine-co-epichlorohydrin-co-ethylenediamine), poly(amidoamine-epichlorohydrin) or cationic starch, or copolymers which contain N-vinylformamide, allylamine, diallyldimethylammonium chloride, N-vinylacetamide, N-vinylpyrrolidone, N-methyl-N-vinylformamide, N-methyl-N-vinylacetamide, dimethylaminopropylmethacrylamide, dimethylaminoethyl acrylate, diethylaminoethyl acrylate, acryloylethyltrimethylammonium chloride or methacrylamidopropyltrimethylammonium chloride in the form of polymerized units and, if desired, in cleaved form, and the salts thereof when the polymers are basic polymers, may be used. Cationic polyvinylformamides, polyvinylamine, cationic polyacrylamide and poly(diallyldimethylammonium chloride) are preferred. Cationic polyvinylformamides are particularly preferred.

Cationic starches are, for example, those starch derivatives, for example starch ethers, which are obtainable by reaction of starch with reagents which contain tertiary amino or quaternary ammonium groups, which reaction is generally carried out in the presence of alkali. Conventional reagents are (2-chloroethyl)diethylamine, (2,3-epoxypropyl)diethylamine, (3-chloropropyl)trimethylammonium chloride, (3-chloro-2-hydroxypropyl)trimethylammonium chloride, (2,3-epoxypropyl)trimethylammonium chloride and (4-chloro-2-butenyl)trimethylammonium chloride, ethylenimine as well as unsubstituted, methyl-substituted or ethyl-substituted cyanamides. Such starch derivatives are described, for example, in Ullmann's Encyclopedia of Industrial Chemistry, Sixth Edition, 2000 Electronic Release-Starch, Section 2.2.6. Cationic Starch, and the literature cited there. The degree of substitution is not limited and may be, for example, from 0.01 to 0.2. Tertiary aminoalkyl ethers, quaternary ammonium ethers and aminoethylated starches are preferred. Both amylose, for example having a molecular weight of from 5 000 to 200 000, and amylopectin may be used as the starch.

The preparation of the cationic polyelectrolytes has long been very well known.

The cationic polyelectrolytes ii) which can be used in the novel process have different molecular weights, which are characterized in this document with the aid of the Fikentscher K values. The molecular weights of the cationic polyelectrolytes which can be used according to the invention are not limited. As a rule, they have K values of from 20 to 200, preferably from 30 to 150, particularly preferably from 40 to 100. The K values stated in this document are determined according to H. Fikentscher in 5% strength aqueous sodium chloride solution at pH 7, 25° C. and a polymer concentration of 0.1% by weight.

The very particularly preferred cationic polyvinylformamides having the polymer formula (I)

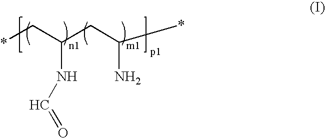

in which the ratio n₁: m₁, based on the total polymer, may be from 99:1 to 1:99 and P₁ may be from 30 to 30 000, or the salts thereof are prepared by polymerizing N-vinylformamide of the formula (II)

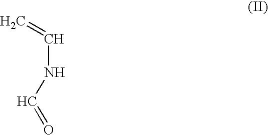

to give a polyvinylformamide of the formula (III) and partially cleaving the latter with removal of the formyl group to give the copolymer (I).

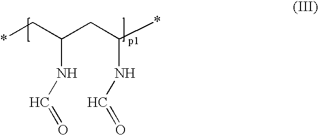

A degree of hydrolysis of the carboxyl group of from 5 to 90, particularly preferably from 10 to 50, mol %, based on the N-carboxamide units contained in the (co)polymer, is preferred. The method of eliminating the formyl group is not limited; it can e effected, for example, in the presence of acid or base, the cleavage in the presence of bases, such as sodium hydroxide, potassium hydroxide, alkaline earth metal hydroxides, ammonia or amines, being preferred. Amphoteric (co)polymers can form as a result of partial hydrolysis, for example of a copolymer containing (meth)acrylates and N-alkyl-N-vinylcarboxamides in the form of polymerized units.

Cationic polymers of N-vinylformamide are obtained in a particularly simple manner by hydrolytically cleaving homopolymers of N-vinylformamide or copolymers containing N-vinylformamide in the form of polymerized units with defined amounts of acid or base to the desired degree of hydrolysis, as described in EP-B1 071 050. The amino groups formed thereby on the polymer chain are protonated to a greater or lesser extent depending on the pH of the solution and thus impart a greater or lesser cationic character to the polymer.

If elimination of the carboxylic acid or formyl group is desired after the (co)polymerization, this can be carried out, for example, in water.

The elimination of the carboxylic acid or formyl group in the hydrolysis is effected at from 20 to 200° C., preferably from 40 to 180° C., in the presence of acids or bases. The hydrolysis in the presence of acids or bases is particularly preferably carried out at from 70 to 90° C.

From about 0.05 to 1.5 equivalents of an acid such as hydrochloric acid, hydrobromic acid, phosphoric acid or sulfuric acid, are required per equivalent of carboxyl or formyl groups in the poly-N-vinylformamide for the acidic hydrolysis. The pH in the acid hydrolysis is from 2 to 0, preferably from 1 to 0. The hydrolysis of N-vinylformamide takes place substantially more rapidly than that of (co)polymers of other N-vinylcarboxamides, for example of N-methyl-N-vinylformamide, and can therefore be carried out under gentler conditions, i.e. at lower temperatures and without a large excess of acids.

Moreover, the hydrolysis of the formyl groups of the poly-N-alkyl-N-vinylcarboxamide should also be carried out in an alkaline medium, for example at a pH of from 11 to 14. This pH is preferably established by adding alkali metal bases, e.g. sodium hydroxide solution or potassium hydroxide solution. However, it is also possible to use ammonia, amines and/or alkaline earth metal bases. For the alkaline hydrolysis, from 0.05 to 1.5, preferably from 0.4 to 1.0, equivalents of a base are used.

The cleavage can also be carried out at high temperatures, for example of 100° C., preferably from 120 to 180° C., particularly preferably from 140 to 160° C., in the presence of a solvent, e.g. water, without acid or base. This is preferably carried out under conditions above the critical point, for example using supercritical water.

In the hydrolysis, i.e. the carboxyl or formyl group is eliminated in water in the presence of acids or bases from the poly-N-vinylcarboxamide, carboxylic acid, for example formic acid, or salts thereof are obtained as a byproduct.

The solutions thus obtainable can be used without further working up in the novel process, but the hydrolysis or solvolysis products can also be separated off.

For separating off, the solutions obtained are treated, for example, with ion exchangers. The residues separated from the hydrolysis products can then be used according to the invention.

The cationic polyacrylamides which can likewise be used for the novel process have been known for many decades (cf. D. Horn, F. Linhart, in Paper Chemistry, ed. J. C. Roberts, 2nd edition, Blackie Academic & Professional, Glasgow (1996), pages 66-67, and literature stated there).

They frequently consist of polymers of the formula (IV),

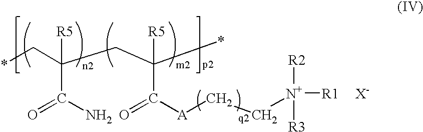

where A is oxygen or a NH group, R¹ may be hydrogen or lower alkyl of 1-3 carbon atoms, R² and R³ may be lower alkyl of 1-5 carbon atoms or benzyl and R⁵ may be hydrogen or methyl, and the ratio n₂ m₂ may be from 99:1 to 0:100, q₂ may be 1 or 2, P₂ may be from 50 to 50 000, X⁻ may be any desired anion, e.g. chloride, bromide, ½ sulfate, hydrogen sulfate, methyl sulfate, ethyl sulfate, methyl carbonate, ethyl carbonate, nitrate, formate, acetate or toluenesulfonate. Moreover, acrylic acid or methacrylic acid may have been incorporated as polymerized units in the polymer chain in an amount such that the total charge of the polymer remains positive independently of the pH.

In this document, lower alkyl is methyl, ethyl, isopropyl, n-propyl, n-butyl, isobutyl, sec-butyl, tert-butyl, n-pentyl, tert-pentyl, isopentyl or sec-amyl.

The poly(diallyldimethylammonium chloride) which can be used in the novel process and has the polymer formula (V),

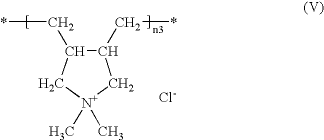

where n₃ may be from 30 to 30 000, has been known for many years (cf. D. Horn, F. Linhart, loc cit, page 70; G. Butler, in Polymeric Amines and Ammonium Salts, ed. E. J. Goethals, Pergamon Press, Oxford (1980), 125).

Other diallyldialkylammonium chlorides are also suitable, for example those having the polymer formula (VI),

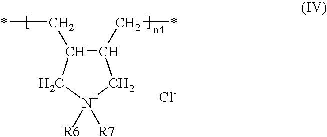

where R⁶ and R⁷, independently of one another, may be hydrogen or lower alkyl of 1 to 4 carbon atoms and n₄ may be from 30 to 30 000.

The other cationic polyelectrolytes mentioned above as examples have also been known for many years.

For the novel process and the novel mixtures, it is of course also possible to use cationic polyelectrolytes which are obtainable by copolymerization of starting monomers of the abovementioned polyelectrolytes. For example, it is also possible to use copolymers which contain vinylformamide (formula (II)) and diallyldimethylammonium chloride or vinylformamide and basic acrylates in the form of polymerized units, as described in EP 0464 043 B1, and copolymers which contain acrylamide and diallyldimethylammonium chloride or other diallyldialkylammonium chlorides in the form of polymerized units are also suitable.

The solubility of the (co)polymers which can be used according to the invention and contain N-vinylcarboxamides in the form of polymerized units, and of other cationic polyelectrolytes, in the solvent iii) used is as a rule at least 1% by weight to complete solubility at 20° C.

The present invention furthermore relates to mixtures B consisting of

i) at least one optical brightener,

ii) at least one cationic polyelectrolyte and

iii) at least one solvent

and, if required, other assistants typical for paper or pigments.

The mixtures B preferably contain only pigments and no assistants typical for paper; mixtures particularly preferably contain no assistants typical for paper and no pigments.

The mixing ratios in the mixtures A or B of the optical brighteners and the (co)polymers, which contain N-vinylcarboxamides in the form of polymerized units and other cationic polyelectrolytes, may be from 1:1 to 1:100, but a substantial excess of cationic polyelectrolytes is advantageous. Mixtures of from 1:2 to 1:50, particularly preferably of from 1:5 to 1:20, are particularly advantageous.

Usually, the novel mixtures B consist of

from 0.05 to 5, preferably from 0.1-3, particularly preferably 0.2-2, % by weight of i),

from 1 to 30, preferably 2-20, particularly preferably 5-15, % by weight of ii) and

from 98.95 to 65, preferably 97.9-77, particularly preferably 94.8-83, % by weight of iii),

based on 100% by weight of mixture.

If other assistants typical for paper (see below) are also contained, the content of solvent iii) is reduced accordingly. The optical brighteners i) which may be used in the mixtures A or B are not limited. For example, optical brighteners as described in Ullmann's Encyclopedia of Industrial Chemistry, Sixth Edition, 2000 Electronic Release, OPTICAL BRIGHTENERS—Chemistry of Technical Products, may be used.

Suitable optical brighteners i) belong, for example, to the group consisting of the distyrylbenzenes, for example cyano-substituted 1,4-distyrylbenzenes having cyano groups in positions 2′ and 3″ [CAS-Reg No. 79026-03-2] or in positions 2′ and 2″ [13001-38-2], 3′ and 3″ [36755-00-7], 3′ and 4″ [79026-O₂-1] and 4′ and 4″ [13001-40-6], or amphoteric compounds, e.g. [84196-71-4] which carry a group

—O—(CH₂)₂—N⁺(C₂H₅)₂—CH₂COO—

in each of the positions 2′ and 2″, to the group consisting of the distyrylbiphenyls, for example, 4,4′-di(2-sulfostyryl)biphenyl disodium salt [27344-41-8], 4,4′-di(3-sulfostyryl)biphenyl disodium salt [51119-63-2], 4,4′-di(4-chloro-3-sulfostyryl)biphenyl disodium salt [42380-62-1], 4,4′-di(6-chloro-3-sulfostyryl)biphenyl disodium salt [60477-28-3], 4,4′-di(2-methoxystyryl)biphenyl [40470-68-6] or a 4,4′-di(styryl)biphenyl which carries a group

—O—(CH₂)₂—N⁺(CH₃)(C₂H₅)₂.CH₃OSO₃—

in position 2 on the styryl radical [72796-88-4], to the group consisting of the divinylstilbenes, for example 4,4′-di(ethoxycarbonylvinyl)stilbene [60683-03-6] or 4,4′-di(cyanovinyl)stilbene [60682-87-3] to the group consisting of the triazinylaminostilbenes, e.g. 1,3,5-triazinyl derivates of 4,4′-diaminostilbene-2,2′-disulfonic acid, such as anilino derivatives which carry the following radicals on the triazine rings in each case in position 3: a methoxy radical (CAS-Reg No. [3426-43-5]), aminomethyl [35632-99-6], ethylamino [24565-13-7], hydroxyethylamino [12224-16-7], N-hydroxyethyl-N-methylamino [13863-31-5], bis(hydroxyethyl)amino [4193-55-9], morpholino [16090-O₂-1], phenylamino [133-66-4], N-2-aminocarbonylethyl-N-2-hydroxyethylamino [68444-86-0] or such as anilinosulfonic acid derivatives which carry the following radicals on the triazine rings in each case in position 3: N-hydroxyethylamino and, additionally on the anilino group in position 5 of the triazine ring, a sulfo group in position 3 (CAS-Reg No. [61968-74-9]), N-bis(hydroxyethyl)amino and, additionally on the anilino group, a sulfo group in position 3 (CAS-Reg No. [12224-O₂-1]), N-bis(2-hydroxypropyl)amino and, additionally on the anilino group, a sulfo group in position 4 (CAS-Reg No. [99549-42-5]), N-bis(hydroxyethyl)amino and, additionally on the anilino group, a sulfo group in position 4 (CAS-Reg No. [16470-24-9]), N-hydroxyethyl-N-methylamino and, additionally on the anilino group, a sulfo group in position 4 (CAS-Reg No. [74228-28-7]), diethylamino and, additionally on the anilino group, sulfo groups in positions 2 and 5 (CAS-Reg No. [83512-97-4]), N-bis(hydroxyethyl)amino and, additionally on the anilino group, sulfo groups in positions 2 and 5 (CAS-Reg No. [76482-78-5]) or morpholino groups and, additionally on the anilino group, sulfo groups in positions 2 and 5 (CAS-Reg No. [55585-28-9]), or to the group consisting of the stilbenyl-2H-triazoles, e.g. stilbenyl-2H-naphtho[1,2-d]-triazoles, such as the sodium salt of 4-(2H-naphtho[1,2-d]-triazol-2-yl)stilbene-2-sulfonic acid [6416-68-8] or those which carry a sulfo group in position 6 on the naphthol ring and at position 2 of the stilbene skeleton [2583-80-4], or a cyano group in position 2 on the stilbene skeleton and a chlorine group in position 4′ [5516-20-1] or, for example, bis(1,2,3-triazol-2-yl)stilbenes, e.g. 4,4′-bis(4-phenyl-1,2,3-triazol-2-yl)stilbene-2,2′-disulfonic acid dipotassium salt [52237-03-3] or 4,4′-bis(4-(4′-sulfophenyl)-1,2,3-triazol-2-yl)stilbene-2,2′-disulfonic acid tetrasodium salt [61968-72-7], or to the group consisting of the benzoxazoles, e.g. stilbenylbenzoxazoles, for example 5,7-dimethyl-2-(4′-phenylstilben-4-yl)benzoxazole [40704-04-9], 5-methyl-2-(4′-(4″-methoxycarbonyl)phenylstilben-4-yl)-benzoxazole [18039-18-4] or those which carry other heterocycles in the 4″ position, e.g. [64893-28-3], or bis(benzoxazoles), e.g. ethylene-, thiophene-, naphthylene-, phenylethylene- or stilbene-bridged bisbenzoxazoles, such as those having CAS numbers [1041-00-5], [2866-43-5], [7128-64-5], [5089-22-5], [1552-46-1], [1533-45-5] or [5242-49-9].

Furthermore, furans, benzo[b]furans and benzimidazoles, e.g. bis(benzo[b]furan-2-yl)biphenyls, for example sulfonated 4,4′-bis(benzo[b]furan-2-yl)biphenyls or cationic benzimidazoles, for example 2,5-di(1-methylbenzimidazol-2-yl)furan [4751-43-3], [72829-17-5], [74878-56-1], [74878-48-1] or [66371-25-3], or 1,3-diphenyl-2-pyrazolines, e.g. 1-(4-amidosulfonylphenyl)-3-(4-chlorophenyl)-2-pyrazoline [2744-49-2], [60650-43-3], [3656-22-2], [27441-70-9], [32020-25-0], [61931-42-8] or [81209-71-4], and tertiary and quaternary amine salts of 1,3-diphenyl-2-pyrazoline derivatives, e.g. [106359-93-7], [85154-08-1], [42952-22-7], [63310-12-3], [12270-54-1] or [36086-26-7], and coumarins, e.g. 7-diethylamino-4-methylcoumarin [91-44-1] and [6025-18-9], [19683-09-1], [3333-62-8], [63660-99-1], [26867-94-7] or [52725-14-1], and naphthalimides, e.g. 4-acetylamino-N-(n-butyl)naphthalimide [3353-99-9], 4-methoxy-N-methylnaphthalimide [3271-05-4], [3271-05-4], [22330-48-9], [25826-31-7], [26848-65-7] or [60317-11-5], and 1,3,5-triazin-2-yl derivatives, for example (4,6-dimethoxy-1,3,5-triazin-2-yl)pyrene [3271-22-5] or 4,4′-di(4,6-diphenyl-1,3,5-triazin-2-yl)stilbene [6888-33-1], can be used.

4,4′-Distyrylbiphenyl derivatives or stilbene derivatives which are substituted by up to 6, particularly preferably by 2, 4 or 6, sulfo groups may preferably be used, preferably the Blankophor® brands from Bayer AG; Blankophor® P and Blankophor® PSG are particularly preferred, the Tinopal® brands from Ciba Specialty Chemicals are furthermore preferred, particularly preferably Tinopal® MC liquid, Tinopal® ABP-Z liquid, Tinopal® SPP-Z liquid and Tinopal® SK-B liquid, and the Leukophor® brands from Clariant AG are furthermore preferred, particularly preferably Leukophor® APN, UO, NS or SHR.

Cationic polyelectrolytes ii) which may be used in the mixtures A or B are those as described above.

Suitable solvents iii) for the novel mixtures A or B are, for example, water, methanol, ethanol, isopropanol, n-propanol, n-butanol, dimethylformamide and N-methylpyrrolidone, water being preferred. The concentration should be chosen so that, owing to, for example, the viscosity of the mixture to be applied, the respective application method can be carried out optimally. Optimum viscosities for various application methods are known to a person skilled in the art.

Conventional concentrations are from 2 to 20% by weight.

The molecular weight of the cationic polyelectrolytes which can be used according to the invention is not limited, as stated above, but should be adapted to the respective application method.

In this document, dispersion is used as an overall term according to Römpp Chemie Lexikon-CD Version 1.0, Stuttgart/N.Y.: Georg Thieme Verlag, 1995, and includes emulsions, suspensions and solutions.

The mixture A or B may be a dispersion in the sense of the abovementioned definition from Römpp-Lexikon, preferably a solution.

The present invention furthermore relates to the use of the novel mixtures B as an additive in paper coating slips.

The use of the novel mixtures B in the novel process is preferred.

The application of the novel mixtures A or B to the surface of a natural paper, of a base paper or of a coated paper can be effected by the methods customary for the surface treatment of paper in the paper industry. Known application units can be used for this purpose, e.g. film presses, size presses, various coating units comprising knife coaters, blades or air brushes, or spray means described, for example, for the application of starch in EP-A 373 276 or for the application of coating slips by V. Nissinen, Wochenblatt für Papierfabrikation, 2001, 11/12, pages 794-806. The application of the mixtures can, however, also be effected during the calandering of paper via the damping means.

The novel process can be carried out in such a way that the mixture A or B is applied to the natural paper or to the raw, uncoated paper or to the finally coated paper, i.e. after a coat when a coat is applied or, on application of a plurality of coats, e.g. preliminary, middle and/or final coat, after one of these coats.

The novel process can be carried out once or several times, for example from one to three times or preferably once or twice, particularly preferably once.

In the case of multiple applications, application can be effected, for example, in each case to the same surface or to different surfaces from among these surfaces, for example once to the base paper, once before and once after the final coat or once after the preliminary coat, once after the middle coat and once after the final coat or once before and once after the final coat.

Application is preferably effected on a natural paper or on a coated paper after the final coat, particularly preferably once or twice, very particularly preferably once.

Of course, the paper coating slips used can in turn contain activators and optical brighteners, for example polyvinyl alcohol, carboxymethylcellulose, anionic or nonionic degraded starches, casein, soybean protein, water-soluble styrene/acrylate copolymers, urea/formaldehyde resins, melamine/formaldehyde resins, polyglycols, acrylic ester-containing copolymers or (co)polymers containing N-vinylcarboxamide in the form of polymerized units.

Of course, the mixture A or B which can be used for the novel process may also contain other assistants typical for paper in addition to the components i), ii) and iii), provided that said assistants do not adversely affect the interactions between i) and ii).

The mixture A or B may furthermore contain pigments, e.g. satin white (calcium sulfoaluminate), calcium carbonate in milled or precipitated form, barium sulfate in milled or precipitated form, kaolin (clay), calcined clay, talc, zinc oxide, silicates or organic pigments, e.g. plastics in particulate form; however, the mixture A or B preferably contains no pigments.

The amount in which the mixture A or B is applied to the paper according to the novel process may vary within wide limits. In general, an amount of from 0.05 to 5, preferably from 0.1 to 3, g, based on the cationic polyelectrolytes, should be applied per m² of paper.

After the application of the mixture A or B to the natural paper or to the raw, precoated paper or or to the finally coated paper drying can be effected, for example, by means of infrared radiators in order to remove any solvent present and, if desired, calandering can also be effected at from 15 to 100° C.

If the mixture A or B is intended not only to increase the whiteness of the paper but also to improve the inkjet printability, it is advisable to choose the somewhat larger application amounts in the abovementioned ranges, for example from 0.1 to 10 g, preferably from 2 to 7 g, particularly preferably from 0.3 to 3 g.

The mixtures may also contain further components known to a person skilled in the art. For example, leveling agents, thickeners, wetting assistants, etc. are suitable.

The mixtures A may furthermore contain, for example, dispersants. Suitable dispersants are polyanions, for example of polyphosphoric acids or of polyacrylic acids (polysalts), which are usually present in amounts of from 0.1 to 3% by weight, based on the amount of pigments.

The mixtures A or B are suitable for use in the novel treatment of recording materials, preferably paper, board or cardboard.

The papers, boards or cardboards treated by means of the novel process can be printed on by conventional methods, e.g. offset, letterpress or gravure printing methods, flexographic printing methods or digital printing methods, such as laser printing or inkjet printing methods.

The novel process makes it easier for a person skilled in the art to perform, with relatively simple means and high flexibility, the difficult task of producing very white paper which can be written on and printed on by various methods.

The examples which follow illustrate the novel process without restricting it to these examples.

Parts, percentages and ppm are by weight, unless stated otherwise.

### EXAMPLES

### Examples for Mixtures

Mixture 1: Aqueous solution containing 10% of a polyvinylformamide having a K value of about 90 and a degree of hydrolysis of 10% and 0.5% (solid) of an optical brightener having 6 sulfo groups (Tinopal® SPP-Z liquid). The viscosity of the mixture, measured according to DIN 53 019, is 1 710 mPa·s (Brookfield, 20 rpm) or 1 660 mPa·s (Brookfield, 100 rpm).

Mixture 2: Aqueous solution containing 10% of a polyvinylformamide having a K value of about 90 and a degree of hydrolysis of 30% and 0.5% (solid) of an optical brightener having 6 sulfo groups (Tinopal® SPP-Z liquid). The viscosity of the mixture, measured according to DIN 53 019, is 1 000 mPa·s (Brookfield, 20 rpm) or 974 mPa·s (Brookfield, 100 rpm).

Mixture 3: Aqueous solution containing 10% of a polyvinylformamide having a K value of about 90 and a degree of hydrolysis of 95% and 0.5% (solid) of an optical brightener having 6 sulfo groups (Tinopal® SPP-Z liquid). The viscosity of the mixture, measured according to DIN 53 019, is 590 mPa·s (Brookfield, 20 rpm) or 575 mPa·s (Brookfield, 100 rpm).

Mixture 4: Aqueous solution containing 10% of diallyldimethylammonium chloride (active substance of the product Catiofast® CS from BASF Aktiengesellschaft) and 0.5% (solid) of an optical brightener having 6 sulfo groups (Tinopal® SPP-Z liquid). The viscosity of the mixture, measured according to DIN 53 019, is 28 mPa·s (Brookfield, 20 rpm) or 53 mPa·s (Brookfield, 100 rpm).

Mixture 5: Aqueous solution containing 10% of a polyvinylformamide having a K value of about 90 and a degree of hydrolysis of 10% and 0.5% (solid) of an optical brightener having 2 sulfo groups (Tinopal® MC liquid). The viscosity of the mixture, measured according to DIN 53 019, is 1 750 mPa·s (Brookfield, 20 rpm) or 1 590 mPa·s (Brookfield, 100 rpm).

Mixture 6: Aqueous solution containing 10% of a polyvinylformamide having a K value of about 90 and a degree of hydrolysis of 30% and 0.5% (solid) of an optical brightener having 2 sulfo groups (Tinopal® MC liquid). The viscosity of the mixture, measured according to DIN 53 019, is 920 mPa·s (Brookfield, 20 rpm) or 900 mPa·s (Brookfield, 100 rpm).

Mixture 7: Aqueous solution containing 10% of a polyvinylformamide having a K value of about 90 and a degree of hydrolysis of 95% and 0.5% (solid) of an optical brightener having 2 sulfo groups (Tinopal® MC liquid). The viscosity of the mixture, measured according to DIN-53 019, is 890 mPa·s (Brookfield, 20 rpm) or 802 mPa·s (Brookfield, 100 rpm).

Mixture 8: Aqueous solution containing 10% of diallyldimethylammonium chloride (active substance of the product Catiofast® CS from BASF Aktiengesellschaft) and 0.5% (solid) of an optical brightener having 2 sulfo groups (Tinopal® MC liquid). The viscosity of the mixture, measured according to DIN 53 019, 26 is 25 mPa·s (Brookfield, 20 rpm) or 49 mPa·s (Brookfield, 100 rpm).

Mixture 9: Aqueous solution containing 10% of cationic polyacrylamide (active substance of the product Luredur® KM 70 from BASF Aktiengesellschaft) and 0.5% (solid) of an optical brightener having 6 sulfo groups (Tinopal® SPP-Z liquid). The viscosity of the mixture neutralized with sodium hydroxide solution, measured according to DIN 53 019, is 7 700 mPa·s (Brookfield, 20 rpm) or 4 460 mPa·s (Brookfield, 100 rpm). For use, this mixture was diluted to 5% of cationic polyacrylamide and 0.25% of optical brightener.

Mixture 10: Aqueous solution containing 10% of a cationic polyvinylpyrrolidone (copolymer of vinylpyrrolidone and vinylimidazole; active substance of the product Luvitec® VPI 55 K 72 W from BASF Aktiengesellschaft) and 0.5% (solid) of an optical brightener having 6 sulfo groups (Tinopal® SPP-Z liquid). The viscosity of the mixture, measured according to DIN 53 019, is 2 080 mPa·s (Brookfield, 20 rpm) or 1 940 mPa·s (Brookfield, 100 rpm). For use, this mixture is diluted to 5% of cationic polyacrylamide and 0.25% of optical brightener.

Mixture 11: Aqueous solution containing 10% of a polyamidoamine/epichlorohydrin resin (active substance of the product Luresin® KNU from BASF Aktiengesellschaft) and 0.5% (solid) of an optical brightener having 6 sulfo groups (Tinopal® SPP-Z liquid). The viscosity of the mixture, measured according to DIN 53 019, is 25 mPa·s (Brookfield, 20 rpm) or 32 mPa·s (Brookfield, 100 rpm).

Mixture 12: Aqueous solution containing 10% of a polyinylformamide having a K value of about 45 and a degree of hydrolysis of 13% and 1.0% (solid) of an optical brightener having 4 sulfo groups (Tinopal® ABP-Z liquid). The viscosity of the mixture, measured according to DIN 53 019, is 73 mPa·s (Brookfield, 20 rpm) or 92 mPa·s (Brookfield, 100 rpm).

Mixture 13: Aqueous solution containing 5% of a polyinylformamide having a K value of about 90 and a degree of hydrolysis of 10% and 0.25% (solid) of an optical brightener having 4 sulfo groups (Tinopal® ABP-Z liquid). The viscosity of the mixture, measured according to DIN 53 019, is 147 mPa·s (Brookfield, 20 rpm) or 160 mPa·s (Brookfield, 100 rpm).

Mixture 14: Aqueous solution containing 5% of a polyinylformamide having a K value of about 90 and a degree of hydrolysis of 30% and 0.25% (solid) of an optical brightener having 4 sulfo groups (Tinopal® ABP-Z liquid). The viscosity of the mixture, measured according to DIN 53 019, is 100 mPa·s (Brookfield, 20 rpm) or 113 mPa·s (Brookfield, 100 rpm).

Mixture 15: Aqueous solution containing 5% of a polyinylformamide having a K value of about 90 and a degree of hydrolysis of 95% and 0.25% (solid) of an optical brightener having 4 sulfo groups (Tinopal® ABP-Z liquid). The viscosity of the mixture, measured according to DIN 53 019, is 70 mPa·s (Brookfield, 20 rpm) or 91 mPa·s (Brookfield, 100 rpm).

Mixture 16: Aqueous solution containing 5% of cationic polyacrylamide (active substance of the product Luredur® KM 70 from BASF Aktiengesellschaft) and 0.25% (solid) of an optical brightener having 4 sulfo groups (Tinopal® ABP-Z liquid). The viscosity of the mixture neutralized with sodium hydroxide solution, measured according to DIN 53 019, is 170 mPa·s (Brookfield, 20 rpm) or 168 mPa·s (Brookfield, 100 rpm).

Mixture 17: Aqueous solution containing 5% of a cationic polyvinylpyrrolidone (copolymer of vinylpyrrolidone and vinylimidazole; active substance of the product Luvitec® VPI 55 K 72 W from BASF Aktiengesellschaft) and 0.25% (solid) of an optical brightener having 4 sulfo groups (Tinopal® ABP-Z liquid). The viscosity of the mixture, measured according to DIN 53 019, is 125 mPa·s (Brookfield, 20 rpm) or 133 mPa·s (Brookfield, 100 rpm).

Mixture 18: Aqueous mixture containing 10% of a cationic starch having a degree of substitution of 0.040-0.045 mol/mol (Solvitose BPN® from AVEBE) and 0.5% (solid) of an optical brightener having 4 sulfo groups (Tinopal® ABP-Z liquid). The viscosity of the mixture, measured according to DIN 53 019, is 0.800 mPa·s (Brookfield, 20 rpm) or 550 mPa·s (Brookfield, 100 rpm).

Mixture 19: Aqueous mixture containing 5% of a cationic starch having a degree of substitution of 0.040-0.045 mol/mol (Solvitose BPN® from AVEBE) and 0.5% (solid) of an optical brightener having 4 sulfo groups (Tinopal® ABP-Z liquid). The viscosity of the mixture, measured according to DIN 53 019, is 645 mPa·s (Brookfield, 20 rpm) or 455 mPa·s (Brookfield, 100 rpm).

Mixture 20: Aqueous mixture containing 10% of a cationic starch having a degree of substitution of 0.040-0.045 mol/mol (Solvitose BPN® from AVEBE) and 0.5% (solid) of an optical brightener having 6 sulfo groups (Tinopal® SPP-Z liquid). The viscosity of the mixture, measured according to DIN 53 019, is 730 mPa·s (Brookfield, 20 rpm) or 503 mPa·s (Brookfield, 100 rpm).

Mixture 21: Aqueous mixture containing 5% of a cationic starch having a degree of substitution of 0.040-0.045 mol/mol (Solvitose BPN® from AVEBE) and 0.5% (solid) of an optical brightener having 6 sulfo groups (Tinopal® SPP-Z liquid). The viscosity of the mixture, measured according to DIN 53 019, is 710 mPa·s (Brookfield, 20 rpm) or 500 mPa·s (Brookfield, 100 rpm).

### Example 1

10% strength (based on polymer) aqueous mixtures of optical brighteners and cationic polyelectrolytes were applied by means of a manual knife coater to a commercial wood-free base paper having the optical properties stated in table 1 so that, after drying, 2 g/m² of the mixture remained on the paper. The paper was dried and calandered according to the prior art. The R 457 brightness of the paper was determined according to DIN 53 145, Part 2. The CIE whiteness of the paper was measured according to ISO 2469. The results of the measurements are shown in table 1.

TABLE 1

| | R 457 | CIE |
|---|---|---|
| Application of | brightness | whiteness |
| None | 89.8 | 94.3 |
| Mixture 1 | 112.5 | 150.9 |
| Mixture 2 | 110.0 | 146.0 |
| Mixture 3 | 110.9 | 145.6 |
| Mixture 4 | 103.5 | 134.3 |

From the measured values of table 1, a person skilled in the art recognizes that the novel use of the novel mixtures results in an unusually large increase in the whiteness of the paper.

### Example 2

10% strength aqueous mixtures of optical brighteners and cationic polymers were applied by means of a manual knife coater to a paper which was provided with 10 g/m² of a coating which corresponds to the prior art and consists of 100 parts of calcium carbonate, 6 parts of starch, 16 parts of a 50% strength polymer dispersion (Styronal® D610 from BASF AG) and smaller amounts of assistants so that, after drying, 1.0 g/m² of the mixture remained on the paper. The paper was dried and calandered according to the prior art. The R 457 brightness of the paper was determined according to DIN 53 145, Part 2. The CIE whiteness of the paper was measured according to ISO 2469. The results of the measurements are shown in table 2.

TABLE 2

| | R 457 | CIE |
|---|---|---|
| Application of | brightness | whiteness |
| None | 88.2 | 86.2 |
| Mixture 1 | 111.6 | 149.7 |
| Mixture 2 | 108.7 | 144.7 |
| Mixture 3 | 108.9 | 143.0 |
| Mixture 4 | 100.4 | 124.9 |

From the measured values of table 2, a person skilled in the art recognizes that the novel use of the novel mixtures results in an unusually large increase in the whiteness of the paper.

### Example 3

10% strength aqueous mixtures of optical brighteners and cationic polyelectrolytes were applied by means of a manual knife coater to a commercial wood-free base paper having the optical properties stated in table 3 so that, after drying, 2 g/m² of the mixture remained on the paper. The paper was dried and calandered according to the prior art. The R 457 brightness of the paper was determined according to DIN 53 145, Part 2. The CIE whiteness of the paper was measured according to ISO 2469. The results of the measurements are shown in table 3.

TABLE 3

| | R 457 | CIE |
|---|---|---|
| Application of | brightness | whiteness |
| None | 89.8 | 95.1 |
| Mixture 5 | 104.6 | 134.7 |
| Mixture 6 | 105.4 | 136.1 |
| Mixture 7 | 110.4 | 144.5 |
| Mixture 8 | 103.2 | 133.1 |

The measured values of table 3 show that the novel use of the novel mixtures results in an unusually great increase in the whiteness of the paper.

### Example 4

10% strength aqueous mixtures of optical brighteners and cationic polymers were applied by means of a manual knife coater to a paper which was provided with 10 g/m² of a coating and consists of 100 parts of calcium carbonate, 6 parts of starch, 16 parts of a 50% strength polymer dispersion (Styronal® D610 from BASF AG) and smaller amounts of assistants so that, after drying, 1.0 g/m² of the mixture remained on the paper. The paper was dried and calandered according to the prior art. The R 457 brightness of the paper was determined according to DIN 53 145, Part 2. The CIE whiteness of the paper was measured according to ISO 2469. The results of the measurements are shown in table 4.

TABLE 4

| | R 457 | CIE |
|---|---|---|
| Application of | brightness | whiteness |
| None | 88.6 | 87.8 |
| Mixture 5 | 106.3 | 139.8 |
| Mixture 6 | 103.8 | 132.8 |
| Mixture 7 | 109.1 | 141.8 |
| Mixture 8 | 100.4 | 124.6 |

It is evident from table 4 that the novel use of the novel mixtures results in an unusually great increase in the whiteness of the paper.

### Example 5

Aqueous mixtures of optical brighteners and cationic polyelectrolytes were applied by means of a manual knife coater to a commercial wood-free base paper having the optical properties stated in table 5 so that, after drying, 2 g/m² of the mixture remained on the paper. The optical brightener Tinopal® SPP-Z liquid alone was also applied to the paper in the same manner. The paper was dried and calandered according to the prior art. The R 457 brightness of the paper was determined according to DIN 53 145, Part 2. The CIE whiteness of the paper was measured according to ISO 2469. The results of the measurements are shown in table 5. The colorimetric values a* and b* of the CIELAB system, which describe the hue of the paper, are also stated.

TABLE 5

| | | | CIELAB system | |
|---|---|---|---|---|
| Application | R 457 | CIE | Colorimetric | Colorimetric |
| of | brightness | whiteness | value a* | value b* |
| None | 89.7 | 93.8 | 0.79 | −1.41 |
| Brightener | 85.3 | 65.7 | −1.51 | 3.94 |
| Mixture 1 | 111.4 | 148.9 | 2.77 | −13.40 |
| Mixture 4 | 103.4 | 135.0 | 3.02 | −10.45 |
| Mixture 9 | 108.4 | 145.9 | 3.42 | −12.82 |
| Mixture 10 | 101.5 | 128.8 | 2.69 | −9.12 |
| Mixture 11 | 100.2 | 125.0 | 2.30 | −8.23 |

It is evident from table 5 that the novel use of the novel mixtures results in an unusually great increase in the whiteness of the paper. It is also possible to see that the application of optical brightener alone leads to a loss of whiteness and, by decreasing the a* and increasing the b* calorimetric value, to the known undesired green coloration of the paper.

### Example 6

Aqueous mixtures of optical brighteners and cationic polyelectrolytes were applied by means of a manual knife coater to a paper which was provided with 10 g/m² of a coating which consisted of 100 parts of calcium carbonate, 6 parts of starch, 16 parts of a 50% strength polymer dispersion (Styronal® D610 from BASF AG) and smaller amounts of assistants so that, after drying, 1.0 g/m² of the mixture remained on the paper. The optical brightener Tinopal SPP-z liquid alone was also applied to the paper in the same manner. The paper was dried and calandered according to the prior art. The R 457 brightness of the paper was determined according to DIN 53 145, Part 2. The CIE whiteness of the paper was measured according to ISO 2469. The results of the measurements are shown in table 6. The calorimetric values a* and b* of the CIELAB system, which describe the hue of the paper, are also stated.

TABLE 6

| | | | CIELAB system | |
|---|---|---|---|---|
| Application | R 457 | CIE | Colorimetric | Colorimetric |
| of | brightness | whiteness | value a* | value b* |
| None | 88.4 | 87.8 | 0.56 | 0.06 |
| Brightener | 84.8 | 63.4 | −1.34 | 4.63 |
| only | | | | |
| Mixture 1 | 110.5 | 147.3 | 2.83 | −13.08 |
| Mixture 4 | 103.4 | 126.4 | 2.79 | −8.38 |
| Mixture 9 | 107.4 | 144.3 | 3.58 | −12.52 |
| Mixture 10 | 99.2 | 121.4 | 2.51 | −7.27 |
| Mixture 11 | 99.1 | 120.2 | 2.37 | −6.96 |

It is evident from table 6 that the novel use of the novel mixtures results in an unusually large increase in the whiteness of the paper. It is also evident that the application of optical brightener alone leads to a loss of whiteness and to the known undesired green coloration of the paper.

### Example 7

Aqueous mixtures of optical brighteners and cationic polyelectrolytes were applied by means of a manual knife coater to a commercial wood-free base paper having the optical properties stated in table 7 so that, after drying, 2 g/m² of the mixture remained on the paper. The paper was dried and calandered according to the prior art. The R 457 brightness of the paper was determined according to DIN 53 145, Part 2. The CIE whiteness of the paper was measured according to ISO 2469. The results of the measurements are shown in table 7.

TABLE 7

| | R 457 | CIE |
|---|---|---|
| Application of | brightness | whiteness |
| None | 89.2 | 94.1 |
| Mixture 12 | 105.3 | 131.1 |
| Mixture 13 | 101.7 | 127.1 |
| Mixture 14 | 101.7 | 127.7 |
| Mixture 15 | 101.1 | 126.1 |
| Mixture 16 | 107.5 | 143.0 |
| Mixture 17 | 104.7 | 136.4 |

### Example 8

Aqueous mixtures of optical brighteners and cationic polymers were applied by means of a manual knife coater to a paper which was provided with 10 g/m² of a coating which corresponds to the prior art and consists of 100 parts of calcium carbonate, 6 parts of starch, 16 parts of a 50% strength polymer dispersion (Styronal® D610 from BASF AG) and smaller amounts of assistants so that, after drying, 1.0 g/m² of the mixture remained on the paper. The paper was dried and calandered according to the prior art. The R 457 brightness of the paper was determined according to DIN 53 145, Part 2. The CIE whiteness of the paper was measured according to ISO 2469. The results of the measurements are shown in table 8.

TABLE 8

| | R 457 | CIE |
|---|---|---|
| Application of | brightness | whiteness |
| None | 88.1 | 86.8 |
| Mixture 12 | 104.6 | 128.4 |
| Mixture 13 | 99.8 | 120.0 |
| Mixture 14 | 99.2 | 118.7 |
| Mixture 15 | 98.6 | 117.2 |
| Mixture 16 | 104.2 | 133.2 |
| Mixture 17 | 102.7 | 130.6 |

From the measured values of tables 7 and 8, a person skilled in the art recognizes that the novel use of the novel mixtures of cationic polyelectrolytes and brighteners from the family consisting of the triazinylaminostilbenes having 4 sulfo groups results in an unusually great increase in the whiteness of the paper.

### Example 9

Aqueous mixtures of optical brighteners and cationic starches were applied by means of a manual knife coater to a commercial wood-free base paper having the optical properties stated in table 9 so that, after drying, 1.5 g/m² of the mixture remained on the paper. Cationic starch alone was also applied to the paper in the same manner. The paper was dried and calandered according to the prior art. The R 457 brightness of the paper was determined according to DIN 53 145, Part 2. The CIE whiteness of the paper was measured according to ISO 2469. The results of the measurements are shown in table 9. The colorimetric values a* and b* of the CIELAB system, which describe the hue of the paper, are also stated.

TABLE 9

| | | | CIELAB system | |
|---|---|---|---|---|
| | R 457 | CIE | Colorimetric | Colorimetric |
| Application of | brightness | whiteness | value a* | value b* |
| None | 88.55 | 92.5 | 0.68 | −1.33 |
| Cationic starch | 87.54 | 92.2 | 0.68 | −1.53 |
| only | | | | |
| Mixture 18 | 101.40 | 126.8 | 2.26 | −8.53 |
| Mixture 19 | 101.60 | 124.5 | 1.51 | −8.00 |
| Mixture 20 | 101.14 | 128.6 | 2.68 | −9.05 |
| Mixture 21 | 104.18 | 135.1 | 2.75 | −10.41 |

It is evident from table 9 that the novel use of the novel mixtures results in an unusually great increase in the whiteness of the paper. It is also evident that the application of cationic starch alone has virtually no effect on the whiteness.

### Example 10

Aqueous mixtures of optical brighteners and cationic starches were applied by means of a manual knife coater to a paper which was provided with 10 g/m² of a coating which consisted of 100 parts of calcium carbonate, 6 parts of starch, 16 parts of a 50% strength polymer dispersion (Styronal® D610 from BASF AG) and smaller amounts of assistants so that, after drying, 1.5 g/m² of the mixture remained on the paper. Cationic starch alone was also applied to the paper in the same manner. The paper was dried and calandered according to the prior art. The R 457 brightness of the paper was determined according to DIN 53 145, Part 2. The CIE whiteness of the paper was measured according to ISO 2469. The results of the measurements are shown in table 10. The colorimetric values a* and b* of the CIELAB system, which describe the hue of the paper, are also stated.

TABLE 10

| | | | CIELAB system | |
|---|---|---|---|---|
| | R 457 | CIE | Colorimetric | Colorimetric |
| Application of | brightness | whiteness | value a* | value b* |
| None | 88.23 | 87.2 | 0.52 | 0.20 |
| Cationic starch | 86.89 | 86.7 | 0.43 | −0.07 |
| only | | | | |
| Mixture 18 | 98.80 | 118.0 | 1.75 | −6.48 |
| Mixture 19 | 99.54 | 116.9 | 1.14 | −6.17 |
| Mixture 20 | 98.82 | 120.4 | 2.38 | −7.06 |
| Mixture 21 | 101.62 | 126.9 | 2.55 | −8.41 |

It is evident from table 10 that the novel use of the novel mixtures results in an unusually great increase in the whiteness of the paper. It is also evident that the application of cationic starch alone has only a slight effect on the whiteness and the hue.

### Examples for Mixtures

Mixture 22: Aqueous solution containing 10% of a polyvinylformamide having a K value of 30.5 and 0.5% (solid) of an optical brightener having 6 sulfo groups (Tinopal® SPP-Z liquid).

Mixture 23: Aqueous solution containing 10% of a polyvinylformamide having a K value of 30.5 and a degree of hydrolysis of 3.3% and 0.5% (solid) of an optical brightener having 6 sulfo groups (Tinopal® SPP-Z liquid).

Mixture 24: Aqueous solution containing 10% of a polyvinylformamide having a K value of 30.5 and a degree of hydrolysis of 1 2.3% and 0.5% (solid) of an optical brightener having 6 sulfo groups (Tinopal® SPP-Z liquid).

Mixture 25: Aqueous solution containing 10% of a polyvinylformamide having a K value of 45.9 and 0.5% (solid) of an optical brightener having 6 sulfo groups (Tinopal® SPP-z liquid).

Mixture 26: Aqueous solution containing 10% of a polyvinylformamide having a K value of 45.9 and a degree of hydrolysis of 5.4% and 0.5% (solid) of an optical brightener having 6 sulfo groups (Tinopal® SPP-Z liquid).

Mixture 27: Aqueous solution containing 10% of a polyvinylformamide having a K value of 45.9 and a degree of hydrolysis of 13.1% and 0.5% (solid) of an optical brightener having-6 sulfo groups (Tinopal® SPP-Z liquid).

Mixture 28: Aqueous solution containing 10% of a polyvinylformamide having a K value of 78.2 and 0.5% (solid) of an optical brightener having 6 sulfo groups (Tinopal® SPP-z liquid).

Mixture 29: Aqueous solution containing 10% of a polyvinylformamide having a K value of 30.5 and 0.5% (solid) of an optical brightener having 2 sulfo groups (Tinopal® MC liquid).

Mixture 30: Aqueous solution containing 10% of a polyvinylformamide having a K value of 45.9 and 0.5% (solid) of an optical brightener having 2 sulfo groups (Tinopal® MC liquid).

Mixture 31: Aqueous solution containing 10% of a polyvinylformamide having a K value of 45.9 and a degree of hydrolysis of 5.4% and 0.5% (solid) of an optical brightener having 2 sulfo groups (Tinopal® MC liquid).

Mixture 32: Aqueous solution containing 10% of a polyvinylformamide having a K value of 45.9 and a degree of hydrolysis of 13.1% and 0.5% (solid) of an optical brightener having 2 sulfo groups (Tinopal® MC liquid).

Mixture 33: Aqueous solution containing 10% of a polyvinylformamide having a K value of 78.2 and 0.5% (solid) of an optical brightener having 2 sulfo groups (Tinopal® MC liquid).

Comparative mixture 1: Aqueous-solution containing 10% of a polyvinyl alcohol (Rhodoviol® R4/20 from Rhodia) and 0.5% (solid) of an optical brightener having 6 sulfo groups (Tinopal® SPP-Z liquid).

Comparative mixture 2: Aqueous solution containing 10% of a polyvinyl alcohol (Rhodoviol® R4/20 from Rhodia) and 0.5% (solid) of an optical brightener having 2 sulfo groups (Tinopal® MC liquid).

### Example 11

10% strength aqueous mixtures of optical brighteners and polymers which contain N-vinylcarboxamides in the form of polymerized units or, for comparison, contain a polyvinyl alcohol (Rhodoviol® R4/20 from Rhodia) corresponding to the prior art were applied by means of a manual knife coater to a commercial wood-free base paper having the optical properties stated in table 11 so that, after drying, 2.5 g/m² of the mixture remained on the paper. The paper was dried, calandered and investigated according to the prior art. The R 457 brightness of the paper was determined according to DIN 53 145, Part 2. The CIE whiteness of the paper was measured according to ISO 2469. The results of the measurements are shown in table 1. The paper was printed with a colored test image using a commercial inkjet printer. With the aid of a standardized measuring method, the bleeding was determined in the test images. The smaller the number in the heading “Bleeding”, the less pronounced is this property and the better is the quality of the printed image.

TABLE 11

| | R 457 | CIE | |
|---|---|---|---|
| Application of | brightness | whiteness | Bleeding |
| None | 90.5 | 97.8 | 2330 |
| Comparative mixture 1 | 102.7 | 134.7 | 2343 |
| Mixture 22 | 104.9 | 138.4 | 2301 |
| Mixture 23 | 104.6 | 137.6 | 2325 |
| Mixture 24 | 104.1 | 135.9 | 1912 |
| Mixture 25 | 105.8 | 140.9 | 1660 |
| Mixture 26 | 105.3 | 139.1 | 1298 |
| Mixture 27 | 104.4 | 136.4 | 1292 |
| Mixture 28 | 106.9 | 143.7 | 986 |

From the measured values of table 11, a person skilled in the art recognizes that the novel use of the novel mixtures results in an unusually great increase in the whiteness of the paper.

Furthermore, it is evident that, in addition to the increase in whiteness, virtually all of the novel mixtures also substantially reduce the bleeding in the printed inkjet image.

### Example 12

10% strength aqueous mixtures of optical brighteners and polymers which contain N-vinylcarboxamides in the form of polymerized units or, for comparison, contain a polyvinyl alcohol (Rhodoviol® R4/20 from Rhodia) corresponding to the prior art were applied by means of a knife coater to a paper which was provided with 10 g/m² of a coating which consists of 100 parts by weight of calcium carbonate, 6 parts of starch, 8 parts of a 50% strength polymer dispersion and smaller amounts of assistants so that, after drying, 1.0 g/m² of the mixture remained on the paper. The paper was dried, calandered and investigated according to the prior art. The R 457 brightness of the paper was determined according to DIN 53 145, Part 2. The CIE whiteness of the paper was measured according to ISO 2469. The results of the measurements are shown in table 12. The paper was printed with a colored test image using a commercial inkjet printer. With the aid of a standardized measuring method, bleeding and wicking were determined in the test images. The smaller the number in the headings “Bleeding” and “Wicking”, the less pronounced are these properties and the better is the quality of the printed image.

TABLE 12

| | R 457 | CIE | | |
|---|---|---|---|---|
| Application of | whiteness | whiteness | Bleeding | Wicking |
| None | 89.2 | 90.2 | 1971 | 985 |
| Comparative mixture 1 | 102.6 | 131.7 | 2663 | 926 |
| Mixture 22 | 106.4 | 138.6 | 1843 | 821 |
| Mixture 23 | 105.7 | 136.7 | 1820 | 909 |
| Mixture 24 | 105.5 | 135.6 | 1031 | 885 |
| Mixture 25 | 105.9 | 137.4 | 2102 | 754 |
| Mixture 26 | 105.7 | 136.4 | 1138 | 801 |
| Mixture 27 | 105.2 | 135.1 | 815 | 800 |
| Mixture 28 | 107.1 | 140.5 | 755 | 747 |

From the measured values of table 12, a person skilled in the art recognizes that the novel use of the novel mixtures results in an unusually great increase in the whiteness of the paper. The considerable improvement in the wicking and in particular in the bleeding in comparison with the untreated paper and especially with comparative mixture 1, which greatly increases the bleeding and thus adversely affects the printed image, is furthermore evident.

### Example 13

10% strength aqueous mixtures of optical brighteners and polymers which contain N-vinylcarboxamides in the form of polymerized units or, for comparison, contain a polyvinyl alcohol (Rhodoviol® R 4/20 from Rhodia) corresponding to the prior art were-applied by means of a manual knife coater to a commercial wood-free base paper having the optical properties stated in table 13 so that, after drying, 2.5 g/m² of the mixture remained on the paper. The paper was dried, calandered and investigated according to the prior art. The R 457 brightness of the paper was determined according to DIN 53 145, Part 2. The CIE whiteness of the paper was measured according to ISO 2469. The results of the measurements are shown in table 13.

The measured values of table 13 show that the novel use of the novel mixtures results in an unusually great increase in the whiteness of the paper. Here too, it is furthermore evident that, in addition to the increase in the whiteness, the novel mixtures also substantially reduce the bleeding in the printed ink-jet image.

TABLE 13

| | R 457 | CIE | |
|---|---|---|---|
| Application of | brightness | whiteness | Bleeding |
| None | 90.8 | 98.9 | 1836 |
| Comparative mixture 2 | 102.8 | 133.2 | 2429 |
| Mixture 29 | 105.9 | 139.9 | 2351 |
| Mixture 30 | 105.8 | 139.5 | 1610 |
| Mixture 31 | 105.4 | 138.2 | 1196 |
| Mixture 32 | 105.8 | 138.6 | 981 |
| Mixture 33 | 107.0 | 142.5 | not |
| | | | measured |

### Example 14

10% strength aqueous mixtures of optical brighteners and polymers which contain-N-vinylcarboxamides in the form of polymerized units or, for comparison, contain a polyvinyl alcohol (Rhodoviol® R4/20 from Rhodia) corresponding to the prior art were applied by means of a knife coater to a paper which was provided with 10 g/m² of a coating which consists of 100 parts of calcium carbonate, 6 parts of starch, 8 parts of a 50% strength polymer dispersion and smaller amounts of assistants so that, after drying, 1.0 g/m² of the mixture remained on the paper. The paper was dried, calandered and investigated according to the prior art. The R 457 brightness of the paper was determined according to DIN 53 145, Part 2. The CIE whiteness of the paper was measured according to ISO 2469. The results of the measurements are shown in table 14.

TABLE 14

| | R 457 | CIE | | |
|---|---|---|---|---|
| Application of | brightness | whiteness | Bleeding | Wicking |
| None | 89.2 | 90.2 | 1968 | 1027 |
| Comparative mixture 2 | 100.4 | 125.3 | 2209 | 1074 |
| Mixture 29 | 102.6 | 129.6 | 1707 | 937 |
| Mixture 30 | 102.4 | 128.8 | 1663 | 700 |
| Mixture 31 | 102.4 | 128.9 | 1141 | 792 |
| Mixture 32 | 102.7 | 129.3 | 868 | 858 |
| Mixture 33 | 103.7 | 132.7 | 760 | 710 |

It is evident from table 14 that the novel use of the novel mixtures results in an unusually great increase in the whiteness of the paper. The considerable improvement in the wicking and in particular in the bleeding in comparison with the untreated paper and especially with comparative mixture 2, which substantially increases the bleeding and thus has an adverse effect on the printed image, is furthermore evident.

1. A process for the production of recording materials, wherein a mixture A comprising
i) at least one optical brightener,
ii) at least one cationic polyelectrolyte and
iii) at least one solvent
is applied to the recording material.

2. A process as claimed in claim 1, wherein the mixture A comprises
from 0.05 to 5% by weight of i),
from 1 to 30% by weight of ii) and
from 98.95 to 65% by weight of iii),
based on 100% by weight of mixture.

3. A mixture B comprising
i) at least one optical brightener,
ii) at least one cationic polyelectrolyte and iii) at least one solvent.

4. A mixture B as claimed in claim 3, comprising
from 0.05 to 5% by weight of i),
from 1 to 30% by weight of ii) and
from 98.95 to 65% by weight of iii),
based on 100% by weight of mixture.

5. A process as claimed in claim 1, wherein the cationic polyelectrolytes are polymeric compounds comprising the polymer building block of the formula (I) 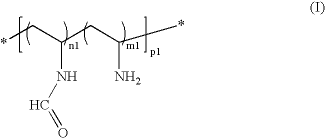
in which the ratio n₁: m₁ may be from 99:1 to 1:99 and p₁ may be from 30 to 30 000, or salts thereof.

6. A process as claimed in claim 1, wherein the cationic polyelectrolytes are polymeric compounds comprising the polymer building block of the formula (IV) 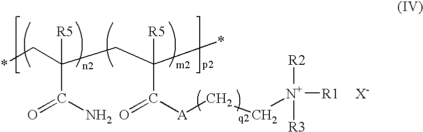
where A is oxygen or an NH group, R¹ may be hydrogen or lower alkyl of 1-3 carbon atoms, R² and R³ may be lower alkyl of 1-5 carbon atoms or benzyl, R⁵ may be hydrogen or methyl, the ratio n₂: m₂ may be from 99:1 to 0:100, q₂ may be 1 or 2, P₂ may be from 50 to 50 000 and X⁻ may be any desired anion.

7. A process as claimed in claim 1, wherein the cationic polyelectrolytes are polymeric compounds comprising the polymer building block of the formula (V), where n₃ may be from 30 to 30 000.

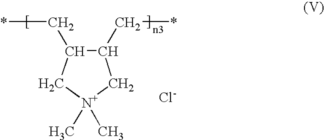

8. A process as claimed in claim 1, wherein the cationic polyelectrolytes are polymeric compounds comprising the polymer building block of the formula (VI) 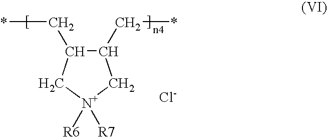
where R⁶ and R⁷, independently of one another, may be hydrogen or lower alkyl of 1 to 4 carbon atoms and n₄ may be from 30 to 30 000.

9. A process as claimed in claim 1, wherein the cationic polyelectrolytes may be polyvinylamine and its salts, polyallylamine and its salts, poly(diallyldimethylammonium chloride)(polyDADMAC), cationic polyvinylformamide, cationic polyvinylpyrrolidone, cationic polyvinylacetamide, cationic polyvinylmethylformamide, cationic polyvinylmethylacetamide, poly(dimethylaminopropylmethacrylamide) (DMAPMAM), poly(dimethylaminoethylacrylate) and its salts, poly(diethylaminoethylacrylate) and its salts, poly(acryloylethyltrimethylammonium chloride), poly(acrylamidopropyltrimethylammonium chloride)(polyAPTAC), poly(methacrylamidopropyltrimethylammonium chloride) (polyMAPTAC), cationic polyacrylamide, poly(vinylpyridine) and its salts, hexadimethrine bromide (Polybren [symbol] ), poly(dimethylamine-co-epichlorohydrin), poly(dimethylamine-co-epichlorohydrin-co-ethylendiamine), poly(amidoamine-epichlorohydrin) or cationic starch or are copolymers which contain N-vinylformamide, allylamine, diallyldimethylammonium chloride, N-vinylacetamide, N-vinylpyrrolidone, N-methyl-N-vinylformamide, N-methyl-N-vinylacetamide, dimethylaminopropylmethacrylamide, dimethylaminoethyl acrylate, diethylaminoethyl acrylate, acryloylethyltrimethylammonium chloride or methacrylamidopropyltrimethylammonium chloride in the form of polymerized units and, if required, in cleaved form, and salts thereof.

10. A process as claimed in claim 1, wherein the cationic polyelectrolyte is a (co)polymer which contains at least one N-vinylcarboxamide of the formula (IIa) in the form of polymerized units 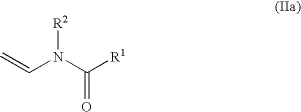
where R¹ and R², independently of one another, are hydrogen or C₁- to C₂₀-alkyl or together are a straight or branched chain containing 2 to 8 carbon atoms.

11. A coated paper or cardboard obtainable by a process as claimed in claim 1.

12. The use of paper or cardboard as claimed in claim 11 in a printing process.

13. The use of a mixture B as claimed in claim 3 as an additive in paper coating slips.

14. The mixture as claimed in claim 3, wherein the cationic polyelectrolytes are polymeric compounds comprising the polymer building block of the formula (I) 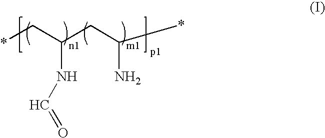
in which the ratio n₁: m₁ may be from 99:1 to 1:99 and p₁ may be from 30 to 30 000, or salts thereof.

15. The mixture as claimed in claim 3, wherein the cationic polyelectrolytes are polymeric compounds comprising the polymer building block of the formula (IV) 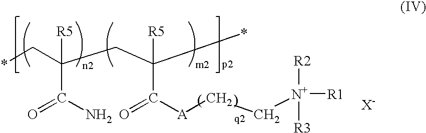
where A is oxygen or an NH group, R¹ may be hydrogen or lower alkyl of 1-3 carbon atoms, R² and R³ may be lower alkyl of 1-5 carbon atoms or benzyl, R⁵ may be hydrogen or methyl, the ratio n₂:m₂ may be from 99:1 to 0:100, q₂ may be 1 or 2, P₂ may be from 50 to 50 000 and X⁻ may be any desired anion.

16. The mixture as claimed in claim 3, wherein the cationic polyelectrolytes are polymeric compounds comprising the polymer building block of the formula (V), where n₃ may be from 30 to 30 000.

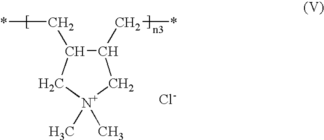

17. The mixture as claimed in claim 3, wherein the cationic polyelectrolytes are polymeric compounds comprising the polymer building block of the formula (VI) 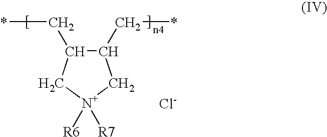
where R⁶ and R⁷, independently of one another, may be hydrogen or lower alkyl of 1 to 4 carbon atoms and n₄ may be from 30 to 30 000.

18. The mixture as claimed in claim 3, wherein the cationic polyelectrolytes may be polyvinylamine and its salts, polyallylamine and its salts, poly(diallyldimethylammonium chloride)(polyDADMAC), cationic polyvinylformamide, cationic polyvinylpyrrolidone, cationic polyvinylacetamide, cationic polyvinylmethylformamide, cationic polyvinylmethylacetamide, poly(dimethylaminopropylmethacrylamide) (DMAPMAM), poly(dimethylaminoethylacrylate) and its salts, poly(diethylaminoethylacrylate) and its salts, poly(acryloylethyltrimethylammonium chloride), poly(acrylamidopropyltrimethylammonium chloride)(polyAPTAC), poly(methacrylamidopropyltrimethylammonium chloride) (polyMAPTAC), cationic polyacrylamide, poly(vinylpyridine) and its salts, hexadimethrine bromide (Polybren [symbol] ), poly(dimethylamine-co-epichlorohydrin), poly(dimethylamine-co-epichlorohydrin-co-ethylendiamine), poly(amidoamine-epichlorohydrin) or cationic starch or are copolymers which contain N-vinylformamide, allylamine, diallyldimethylammonium chloride, N-vinylacetamide, N-vinylpyrrolidone, N-methyl-N-vinylformamide, N-methyl-N-vinylacetamide, dimethylaminopropylmethacrylamide, dimethylaminoethyl acrylate, diethylaminoethyl acrylate, acryloylethyltrimethylammonium chloride or methacrylamidopropyltrimethylammonium chloride in the form of polymerized units and, if required, in cleaved form, and salts thereof.

19. The mixture as claimed in claim 3, wherein the cationic polyelectrolyte is a (co)polymer which contains at least one N-vinylcarboxamide of the formula (IIa) in the form of polymerized units 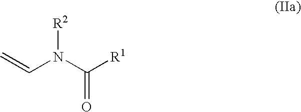
where R¹ and R², independently of one another, are hydrogen or C₁- to C₂₀-alkyl or together are a straight or branched chain containing 2 to 8 carbon atoms.
